(19) United States
(12) Patent Application Publication
(10) Pub. No.: US 2016/0041320 A1
(43) Pub. Date: Feb. 11, 2016

(54) METHOD FOR PRODUCING OPTICALLY ANISOTROPIC FILM

(71) Applicant: SUMITOMO CHEMICAL COMPANY, LIMITED, Tokyo (JP)

(72) Inventor: Tadahiro KOBAYASHI, Osaka-shi, Osaka (JP)

(21) Appl. No.: 14/392,100

(22) PCT Filed: Apr. 10, 2014
(86) PCT No.: PCT/JP2014/060884

§ 371 Date: Oct. 9, 2015

(30) Foreign Application Priority Data
Apr. 11, 2013 (JP) 2013-082696

(51) Int. Cl. G02B 5/30

(52) U.S. Cl. CPC G02B 5/3016

(57) ABSTRACT

A method for producing an optically anisotropic film is provided. The method includes a step of coating a composition for forming an optically anisotropic layer containing a polymerizable liquid crystal compound and a photopolymerization initiator onto the surface of an orientation layer, and a step of irradiating the coated composition for forming an optically anisotropic layer with light in an atmosphere of 0.5% or less of oxygen concentration, while keeping the composition for forming an optically anisotropic layer at a liquid crystal-liquid phase transition temperature of the polymerizable liquid crystal compound or less.

### TECHNICAL FIELD

The present invention relates to a method for producing an optically anisotropic film.

### BACKGROUND ART

A flat panel display device (FPD) makes use of a member including an optically anisotropic film such as a polarizing plate or a retardation plate. As such an optically anisotropic film, known is an optically anisotropic film produced by coating a composition containing a polymerizable liquid crystal compound onto a substrate. For example, Patent Document 1 describes a method for producing an optically anisotropic film including coating a composition containing a polymerizable liquid crystal compound onto a substrate subjected to orienting treatment, thereby obtaining a coating layer, and irradiating the coating layer with light to polymerize the polymerizable liquid crystal compound. However, the conditions in irradiating light are not described.

### PRIOR ART DOCUMENT

### Patent Document

Patent Document 1: JPA-2007-148098

### SUMMARY OF THE INVENTION

### Problems to be Solved by the Invention

According to the conventional method for producing an optically anisotropic film, transparency of the resultant, optically anisotropic film and durability of optical anisotropy have not been sufficient.

### Means for Solving the Problems

The present invention includes the following inventions.

[1] A method for producing an optically anisotropic film including the following steps (1) and (2):
(1) a step of coating a composition for forming an optically anisotropic layer containing a polymerizable liquid crystal compound and a photopolymerization initiator onto the surface of an orientation layer, and
(2) a step of irradiating the coated composition for forming an optically anisotropic layer with light in an atmosphere of 0.5% or less of oxygen concentration, while keeping the composition for forming an optically anisotropic layer at a liquid crystal-liquid phase transition temperature of the polymerizable liquid crystal compound or less.
[2] The method for producing an optically anisotropic film according to item [1], wherein, in the step (2), the temperature for keeping the coated composition for forming an optically anisotropic layer is 80° C. or less.
[3] The method for producing an optically anisotropic film according to item [1] or [2], wherein, in the step (2), the time for irradiating the coated composition for forming an optically anisotropic layer with light is 5 seconds to 10 minutes.
[4] The method for producing an optically′anisotropic film according to any of items [1] to [3], wherein, in the step (2), the oxygen concentration is 0.1% or less.
[5] The method for producing an optically anisotropic film according to any of items [1] to [4], wherein the orientation layer is formed on the surface of the substrate.
[6] The method for producing an optically anisotropic film according to item [5], including bringing the surface on the opposite side of the substrate surface on which the orientation layer is formed into contact with a refrigerant circulation roll, and photoirradiating it while keeping the substrate surface at 80° C. or less.
[7] The method for producing an optically anisotropic film according to item [6], wherein the temperature of a refrigerant flowed through the refrigerant circulation roll is 4° C. to 30° C.
[8] The method for producing an optically anisotropic film according to item [6] or [7], wherein the time for bringing the surface on the opposite side of the substrate surface on which the orientation layer is formed into contact with a refrigerant circulation roll is 5 seconds to 10 minutes.
[9] The method for producing an optically anisotropic film according to any of items [5] to [8], wherein the substrate is a rolled substrate, and the steps (1) and (2) as described in item [1] are continuously performed.
[10] An optically anisotropic film obtained by performing the following steps (1) and (2):
(1) a step of coating a composition for forming an optically anisotropic layer containing a polymerizable liquid crystal compound and a photopolymerization initiator onto the surface of an orientation layer, and
(2) a step of irradiating the coated composition for forming an optically anisotropic layer with light in an atmosphere of 0.5% or less of oxygen concentration, while keeping the composition for forming an optically anisotropic layer at a liquid crystal-liquid phase transition temperature of the polymerizable liquid crystal compound or less.
[11] The optically anisotropic film according to item [10]formed from a vertically oriented polymerizable liquid crystal compound.
[12] The optically anisotropic film according to item [10] or [11], wherein the front retardation value Re(549) is 0 nm to 10 nm, and the retardation value Rₜₕ, of thickness direction is −10 nm to −300 nm.
[13] The optically anisotropic film according to any of items [10] to [12], which is for an in-plane switching (IPS) liquid crystal display device.
[14] A polarizing plate having the optically anisotropic film as described in any of items [10] to [13]. [15] The polarizing plate according to item [14], wherein the degree of polarization is 99.97%.
[16] A display device, including the optically anisotropic film as described in any of items [10] to [13].

### Effect of the Invention

According to the present invention, an optically anisotropic film which is excellent in transparency and durability of optical anisotropy can be produced.

### BRIEF DESCRIPTION OF THE DRAWINGS

FIGS. 1(a) to 1(e) are each a schematic view illustrating an example of the polarizing plate according to the present invention.

FIGS. 2(a) and 2 (b) are each a schematic view illustrating an example of the display device according to the present invention.

FIG. 3 is a schematic view illustrating an example of the photoirradiation unit according to the present invention.

### MODE FOR CARRYING OUT THE INVENTION

The method for producing an optically anisotropic film of the present invention includes the following steps (1) and (2):

(1) a step of coating a composition for forming an optically anisotropic layer containing a polymerizable liquid crystal compound and a photopolymerization initiator onto the surface of an orientation layer, and
(2) a step of irradiating the coated composition for forming an optically anisotropic layer with light in an atmosphere of 0.5% or less of oxygen concentration, while keeping the composition for forming an optically anisotropic layer at a liquid crystal-liquid phase transition temperature of the polymerizable liquid crystal compound or less.

An orientation layer is usually formed on the surface of the substrate. A transparent substrate is usually used as the substrate. The transparent substrate means a substrate having such a translucency that light, in particular, visible rays can be transmitted through the substrate. Translucency denotes a property that the transmittance to light rays having wavelengths from 380 nm to 780 nm is 80% or more. Specific examples of the transparent substrate include glass and translucent resin substrates, and preferred is a translucent resin substrate. As the substrate, a substrate in a film form is usually used, and a rolled film is preferably used.

Examples of the resin that constitutes the substrate include polyolefins such as polyethylene, polypropylene, and norbornene-based polymers; polyvinyl alcohol; polyethylene terephthalate; polymethacrylates; polyacrylates; cellulose esters; polyethylene naphthalate; polycarbonates; polysulfones; polyethersulfones; polyetherketones; polyphenylenesulfides; and polyphenylene oxides. Among them, the resin is preferably a substrate made of polyolefin such as polyethylene, polypropylene or norbornene-based polymer.

The substrate may be subjected to surface treatment. Examples of the method for the surface treatment include a method of treating a surface of the substrate with corona or plasma in a vacuum or an atmospheric pressure; a method of treating a surface of the substrate with a laser; a method of treating a surface of the substrate with ozone; a method of subjecting a surface of the substrate to saponifying treatment or a method of subjecting a surface of the substrate to flame treatment; a method of coating a coupling agent onto a surface of the substrate; a method of subjecting to primer treatment; a graft-polymerization method of causing a reactive monomer or a polymer having reactivity to adhere onto a surface of the substrate, and then irradiating the monomer or polymer with radial rays to cause a reaction of the monomer or polymer; and the like. Among them, preferred is the method of treating a surface of the substrate with corona or plasma in a vacuum or an atmospheric pressure.

Examples of the method of treating a surface of the substrate with corona or plasma include a method of setting the substrate between opposed electrodes under a pressure close to the atmospheric pressure, and generating corona or plasma to treat the surface of the substrate therewith; a method of causing a gas to flow into the gap between opposed electrodes, making the gas into plasma between the electrodes, and blowing the plasma-state gas onto the substrate; and a method of generating glow discharge plasma under a low pressure to treat the surface of the substrate therewith.

Among them, preferred are the method of setting the substrate between opposed electrodes under a pressure close to the atmospheric pressure, and then generating corona or plasma to treat the surface of the substrate therewith, and the method of causing a gas to flow into the gap between opposed electrodes, making the gas into plasma between the electrodes, and blowing the plasma-state gas onto the substrate. Usually, these surface treatments with corona or plasma can be conducted in a commercially available surface treatment apparatus.

The orientation layer herein is preferably a layer that does not dissolve in the composition for forming an optically anisotropic layer, is not deteriorated by removing the solvent contained in the composition for forming an optically anisotropic layer and by heating for adjusting liquid crystal orientation of the polymerizable liquid crystal compound, and does not cause peeling due to friction or the like during transporting the film.

Examples of the method for producing an orientation layer include a method of coating an orienting polymer onto the surface of the substrate and drying it; a method of coating an orienting polymer, drying it, and rubbing the surface thereof; a method of coating a photo-orienting polymer, drying it, and irradiating it with polarized light; a method of vapor-depositing silicon oxide obliquely; a method of forming a monomolecular film having a long chain alkyl group using the Langmuir-Blodgett method (LB method); and the like.

The orienting polymer and the photo-orienting polymer are usually dissolved in a solvent and coated.

Examples of the orienting polymer include polyamides and gelatins, which each have amide bonds in the molecule, polyimides which each have imide bonds in the molecule, polyamic acids which are each a hydrolyzate of a polyimide, polyvinyl alcohols, alkyl-modified polyvinyl alcohols, polyacrylamides, polyoxazoles, polyethyleneimines, polystyrenes, polyvinyl pyrrolidones, polyacrylic acids, polyacrylates, and the like. Among them, the orienting polymer is preferably polyamide, polyimide or a polyamic acid. The orienting polymer forming the orientation layers may be one kind, a composition obtained by combining plural kinds of polymers, or a copolymer having plural kinds of polymers. These polymers can be easily obtained by polycondensation such as dehydration and dealcoholization, chain polymerization such as radical polymerization, anion polymerization and cation polymerization, coordination polymerization, ring-opening polymerization or the like, of a monomer.

Examples of the commercially available orienting polymer include products SUNEVER (registered trademark, manufactured by Nissan Chemical Industries, Ltd.), OPTMER (registered trademark, manufactured by JSR Corporation.), and the like.

The orientation layer composed of such orienting polymer facilitates the liquid crystal orientation of the polymerizable liquid crystal compound. In accordance with the kind of the orienting polymer, or rubbing conditions, various liquid crystal orientations such as horizontal orientation, vertical orientation, hybrid orientation and oblique orientation can be controlled, and can be utilized for improvement of a viewing angle of various liquid crystal panels, and the like.

The photo-orienting polymer includes a polymer having a photosensitive structure. When the polymer having a photosensitive structure is irradiated with polarized light, the photosensitive structure in the irradiated portion is isomerized or crosslinked such that the photo-orienting polymer is oriented, and orientation regulating force is given to a layer made of the photo-orienting polymer. Examples of the photosensitive structure include an azobenzene structure, a maleimide structure, a chalcone structure, a cinnamic acid structure, a 1,2-vinylene structure, a 1,2-acetylene structure, a spiropyran structure, a spirobenzopyrane structure, a fulgide structure, and the like. The photo-orienting polymer forming an orientation layer may be one kind, a combination of a plurality of polymers having different structures, or a copolymer having a plurality of different photosensitive structures. The photo-orienting polymer can be obtained by polycondensation such as dehydration and dealcoholization, chain polymerization such as radical polymerization, anion polymerization and cation polymerization, coordination polymerization, ring-opening polymerization or the like, of a monomer having a photosensitive structure. Examples of the photo-orienting polymer include photo-orienting polymers described in Japanese Patent Nos. 4450261 and 4011652, JP-A-2010-49230, Japanese Patent No. 4404090, JP-A-2007-156439, JP-A-2007-232934, and the like. Among them, as the photo-orienting polymer, a polymer forming crosslinked structure by polarized light irradiation is preferred, from the viewpoint of durability.

Among them, in the present invention, from the viewpoint of orientation uniformity of the polymerizable liquid crystal compound, production time and production cost of the optically anisotropic film, preferred are the method of coating an orienting polymer and drying it, and the method of coating an orienting polymer, drying it, and rubbing the surface thereof.

Examples of the solvent to dissolve an orienting polymer or photo-orienting polymer include water; alcohol solvents such as methanol, ethanol, ethylene glycol, isopropyl alcohol, propylene glycol, methylcellosolve, and butylcellosolve; ester solvents such as ethyl acetate, butyl acetate, ethylene glycol methyl ether acetate, γ-butyrolactone, propylene glycol methyl ether acetate, and ethyl lactate; ketone solvents such as acetone, methyl ethyl ketone, cyclopentanone, cyclohexanone, methyl amyl ketone, methyl isobutyl ketone, and N-methyl-2-pyrrolidone; aliphatic hydrocarbon solvents such as pentane, hexane, heptane, and ethylcyclohexane; aromatic hydrocarbon solvents such as toluene, xylene, and chlorobenzene; nitrile solvents such as acetonitrile; ether solvents such as propylene glycol monomethyl ether, tetrahydrofuran, and dimethoxyethane; halogenated hydrocarbon solvents such as chloroform; and the like. Such organic solvents may be used alone or in combination.

The solvent is usually 10 parts by mass to 100000 parts by mass, preferably 1000 parts by mass to 50000 parts by mass, and more preferably 2000 parts by mass to 20000 parts by mass, related to 100 parts by mass of the orienting polymer or photo-orienting polymer.

Examples of the method for dissolving an orienting polymer or photo-orienting polymer in a solvent and coating it onto the substrate include extrusion coating, direct gravure coating, reverse gravure coating, CAP coating, die coating methods, and the like. Also, examples include a method of coating using a coater such as a dip coater, a bar coater or a spin coater.

Examples of the drying method include natural drying, ventilation drying, heat drying, and reduced-pressure drying; and any combination of these methods. The drying temperature is preferably from 10° C. to 250° C., and more preferably from 25° C. to 200° C. The drying time, which depends on the kind of the solvent, is preferably from 5 seconds to 60 minutes, and more preferably from 10 seconds to 30 minutes.

Examples of the method for the rubbing include a method of bringing a rubbing-cloth-wound rubbing roll that is being rotated into contact with the orienting polymer coated onto the substrate and dried.

Examples of the method for irradiating polarized light include a method using a device described in JP-A-2006-323060. In addition, a patterned orientation layer can be also formed by repeatedly irradiating each region with polarized light such as linear polarized ultraviolet rays, via photomask corresponding to a plurality of desired regions. As the photomask, one provided with a shielding pattern on a film such as quartz glass, soda lime glass or polyester is usually used. In the portion covered with the shielding pattern, polarized light to be irradiated is shielded, and in the portion not being covered, polarized light to be irradiated is transmitted. Quartz glass is preferred in that the influence of thermal expansion is small. The polarized light to be irradiated is preferably ultraviolet ray, from the viewpoint of reactivity of the photo-orienting polymer.

The thickness of the orientation layer is usually from 10 nm to 10000 nm, and preferably from 10 nm to 1000 nm.

It is preferred when the thickness of the orientation layer is in the above range, since the polymerizable liquid crystal compound can be easily liquid-crystal-oriented in the desired direction or angle.

The composition for forming an optically anisotropic layer contains a polymerizable liquid crystal compound and a photopolymerization initiator.

Examples of the polymerizable liquid crystal compound include compounds containing a group represented by a formula (X) (hereinafter, may be referred to as the “compound (X)”). About the polymerizable liquid crystal compound, a single species thereof may be used, or a plurality of species different from each other in structure may be used in combination.

P¹¹-B¹¹-E¹¹-B¹²-A¹¹-B¹³- (X)

wherein P¹¹ represents a polymerizable group;

A¹¹ represents a bivalent alicyclic hydrocarbon group or bivalent aromatic hydrocarbon group provided that any hydrogen atom contained in the bivalent alicyclic hydrocarbon group or bivalent aromatic hydrocarbon group is optionally substituted with a halogen atom, an alkyl group having 1 to 6 carbon atoms, an alkoxy group having 1 to 6 carbon atoms, a cyano group or a nitro group provided that any hydrogen atom contained in the alkyl group having 1 to 6 carbon atoms or the alkoxy group having 1 to 6 carbon atoms is optionally substituted with a fluorine atom;

B¹¹ represents —O—, —S—, —CO—O—, —O—CO—, —O—CO—O—, —CO—NR¹⁶—, —NR¹⁶—CO—, —CO—, —CS— or a single bond wherein R¹⁶s each represent a hydrogen atom or an alkyl group having 1 to 6 carbon atoms;

B¹² and B¹³ each independently represent —C≡C—, —CH═CH—, —CH₂—CH₂—, —O—, —S—, —C(═O)—, —C(═O)—O—, —O—C(═O)—, —O—C(═O)—O—, —CH═N—, —N═CH—, —N═N—, —C(═O)—NR¹⁶—, —NR¹⁶—C(═O)—, —OCH₂—, —OCF₂—, —CH₂O—, —CF₂O—, —CH═CH—C(═O)—O—, —O—C(═O)—CH═CH—, or a single bond;

E¹¹ represents an alkanediyl group having 1 to 12 carbon atoms provided that any hydrogen atom contained in the alkanediyl group is optionally substituted with an alkoxy group having 1 to 5 carbon atoms provided that any hydrogen atom contained in the alkoxy group is optionally substituted with a halogen atom; and also, any —CH₂— that constitutes the alkanediyl group is optionally replaced with —O— or —CO—.

The number of the carbon atoms of the bivalent aromatic hydrocarbon group and bivalent alicyclic hydrocarbon group represented by A¹¹ is preferably in the range of 3 to 18, more preferably in the range of 5 to 12, and particularly preferably 5 or 6. A¹¹ is preferably a cyclohexane-1,4-diyl group, or 1,4-phenylene group.

As the alkanediyl group having 1 to 12 carbon atoms represented by E¹¹, preferred is a linear alkanediyl group having 1 to 12 carbon atoms. Any —CH₂— that constitutes the alkanediyl group having 1 to 12 carbon atoms is optionally replaced with —O—.

Specific examples thereof include linear alkanediyl groups having 1 to 12 carbon atoms, such as methylene, ethylene, propane-1,3-diyl, butane-1,4-diyl, pentane-1,5-diyl, hexane-1,6-diyl, heptane-1,7-diyl, octane-1,8-diyl, nonane-1,9-diyl, decane-1,10-diyl, undecane-1,11-diyl, and dodecane-1,12-diyl groups; —CH₂—CH₂—O—CH₂—CH₂—, —CH₂—CH₂—O—CH₂—CH₂—O—CH₂—CH₂—, and —CH₂—CH₂—O—CH₂—CH₂—O—CH₂—CH₂—O—CH₂—CH₂—; and the like.

B¹¹ is preferably —O—, —S—, —CO—O—, or —O—CO—, and more preferably —CO—O—.

B¹² and B¹³ are each independently preferably —O—, —S—, —C(═O)—, —C(═O)—O—, —O—C(═O)—, or —O—C(═O)—O—, and more preferably —O— or —O—C(═O)—O—.

The polymerizable group represented by P¹¹ is preferably a radical polymerizable group or cation polymerizable group in that it is easy to cause a photopolymerization reaction. The polymerizable group is preferably a group represented by any one of the following formulae (P-11) to (P-15) since the polymerizable liquid crystal compound having the group is easy to handle, and is also easily produced:

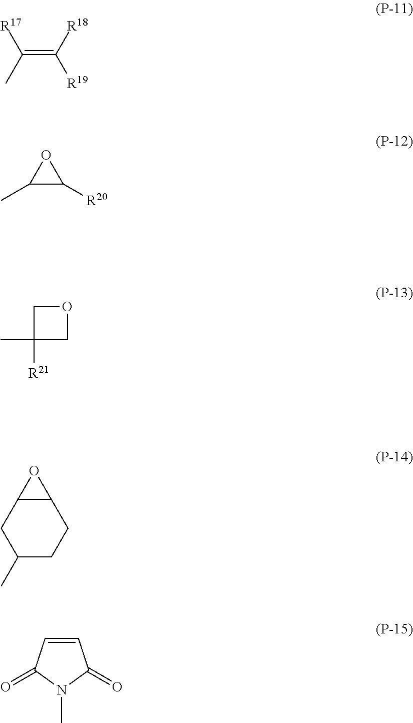

wherein

R¹⁷ to R²¹ each independently represent an alkyl group having 1 to 6 carbon atoms, or a hydrogen atom.

Specific examples of the group represented by any one of the formulae (P-11) to (P-13) include respective groups represented by the following formulae (P-16) to (P-20).

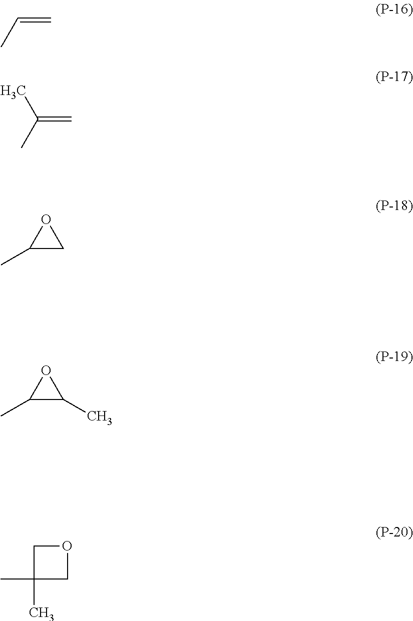

P¹¹ is preferably a group represented by any one of the formulae (P-14) to (P-20), and more preferably a vinyl, p-stilbene group, epoxy or oxetanyl group.

Further preferably, the group represented by P¹¹-B¹¹- is an acryloyloxy or methacryloyloxy group.

Examples of the compound (X) include respective compounds represented by the formulae (I), (II), (III), (IV), (V) and (VI):

P¹¹-B¹¹-E¹¹-B¹²-A¹¹-B¹³-A¹²-B¹⁴-A¹³-B¹⁵-A¹⁴-B¹⁶-E¹²-B¹⁷-P¹² (I)

P¹¹-B¹¹-E¹¹-B¹²-A¹¹-B¹³-A¹²-B¹⁴-A¹³-B¹⁵-A¹⁴-F¹¹ (II)

P¹¹-B¹¹-E¹¹-B¹²-A¹¹-B¹³-A¹²-B¹⁴-A¹³-B¹⁵-E¹²-B¹⁷-P¹² (III)

P¹¹-B¹¹-E¹¹-B¹²-A¹¹-B¹³-A¹²-B¹⁴-A¹³-F¹¹ (IV)

P¹¹-B¹¹-E¹¹-B¹²-A¹¹-B¹³-A¹²-B¹⁴-E¹²-B¹⁷-P¹² (V)

P¹¹-B¹¹-E¹¹-B¹²-A¹¹-B¹³-A¹²-F¹¹ (VI)

wherein

A¹² to A¹⁴ each independently have the same meaning as A¹¹; B¹⁴ to B¹⁶ each independently have the same meaning as B¹²; B¹⁷ has the same meaning as B¹¹; E¹² has the same meaning as E¹¹; and

F¹¹ represents a hydrogen atom, an alkyl group having 1 to 13 carbon atoms, an alkoxy group having 1 to 13 carbon atoms, a cyano group, a nitro group, a trifluoromethyl group, a dimethylamino group, a hydroxyl group, a methylol group, a formyl group, a sulfo group (—SO₃H), a carboxyl group, an alkoxycarbonyl group having 1 to 10 carbon atoms, or a halogen atom, provided that any —CH₂— that constitutes the alkyl group and alkoxy group is optionally replaced with —O—.

Specific examples of the polymerizable liquid crystal compound include compounds each having a polymerizable group out of compounds described in “3.8.6 Network (Completely Crosslinked Type)” and “6.5.1 Liquid Crystal Material, b. Polymerizable Nematic Liquid Crystal Material” in “Liquid Crystal Handbook” (edited by Liquid Crystal Handbook Editorial Committee, and published by Maruzen Publishing Co., Ltd. on Oct. 30, 2000); and polymerizable liquid crystal compounds described in JP-A-2010-31223, JP-A-2010-270108, JP-A-2011-6360, and JP-A-2011-207765.

Specific examples of the compound (X) include compounds represented by following formulae (I-1) to (I-4), formulae (II-1) to (II-4), formulae (III-1) to (III-26), formulae (IV-1) to (IV-26), formulae (V-1) and (V-2), and formulae (VI-1) to (VI-6). In the following formulae, k1 and k2 each independently represent an integer of 2 to 12. These compounds (X) are preferred since the compounds are easily synthesized or are easily available.

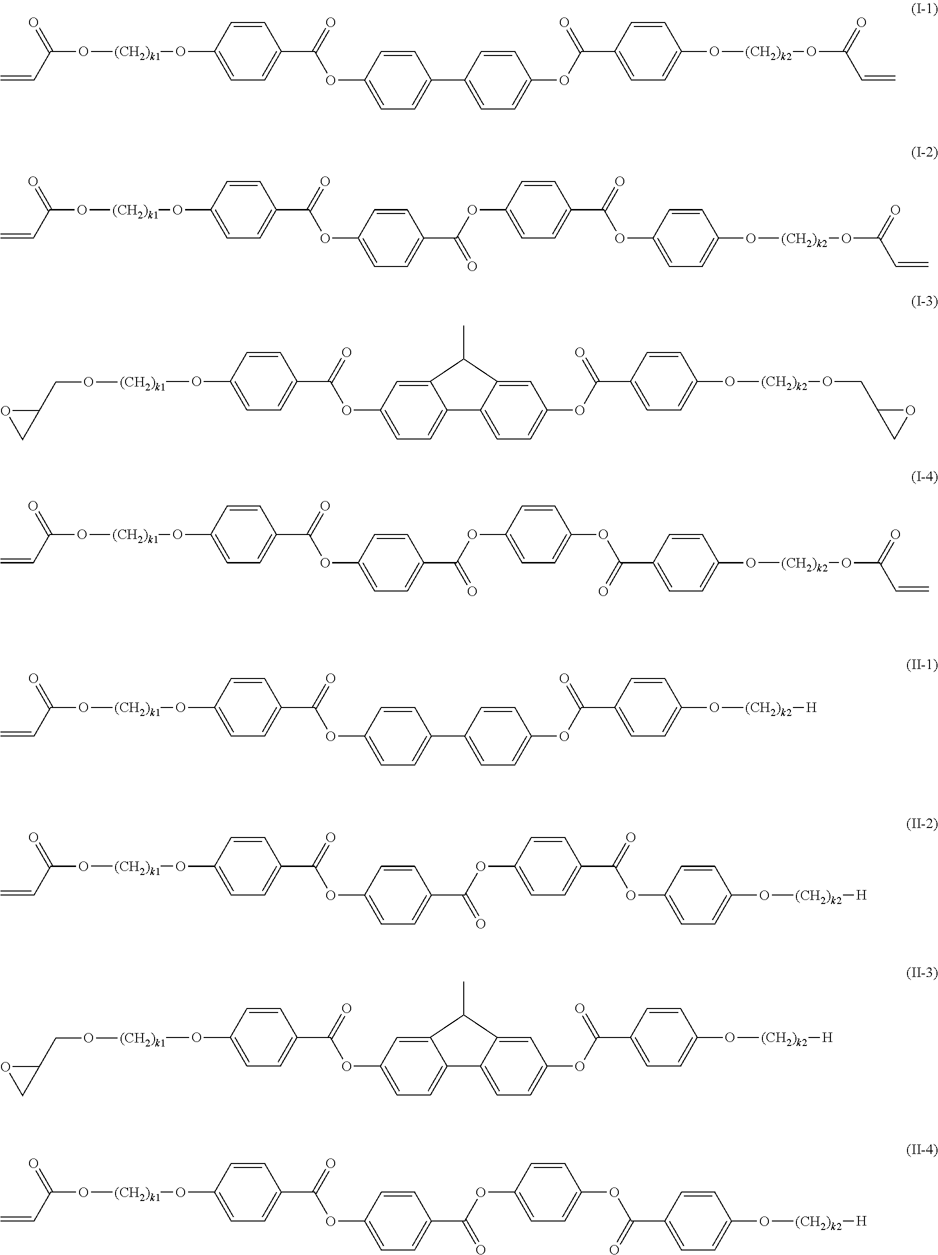

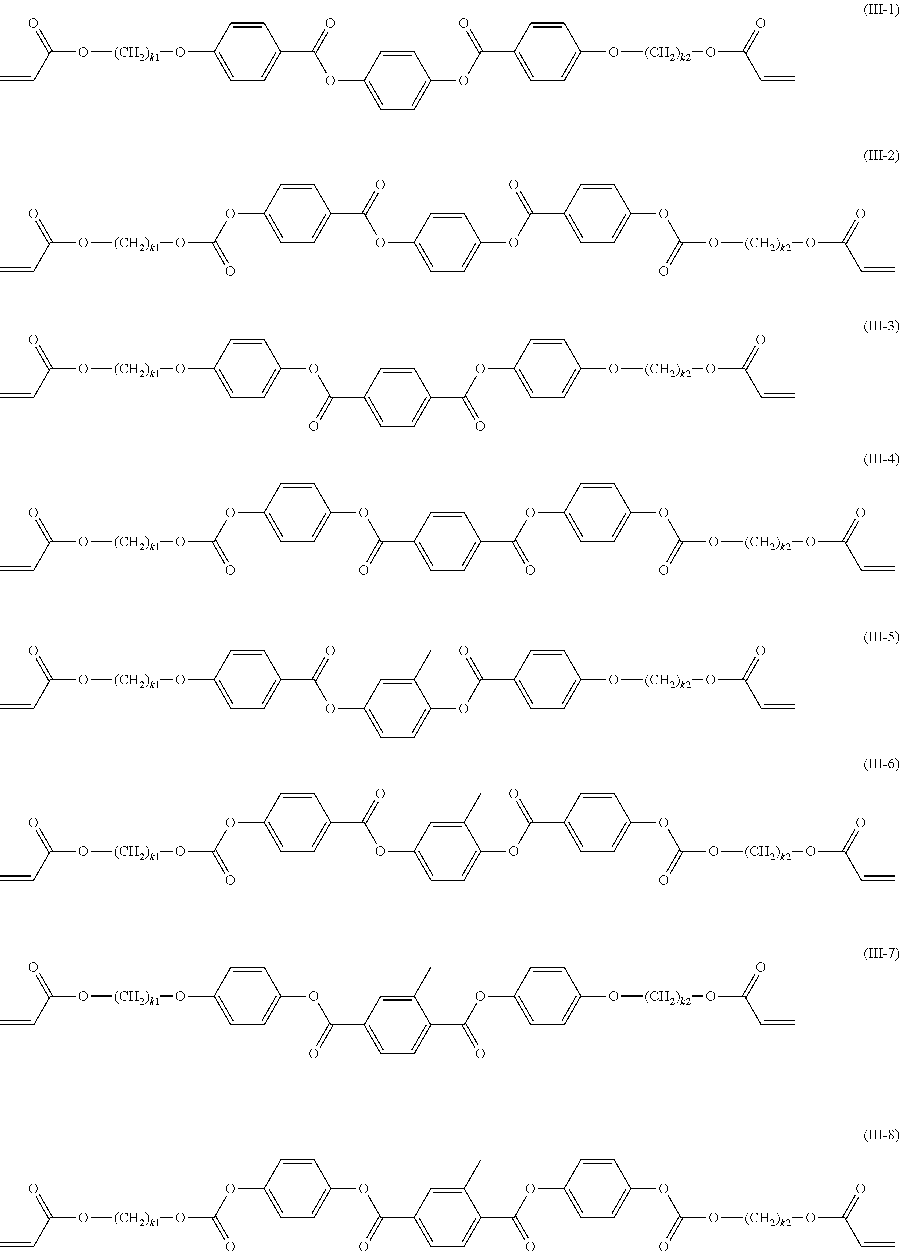

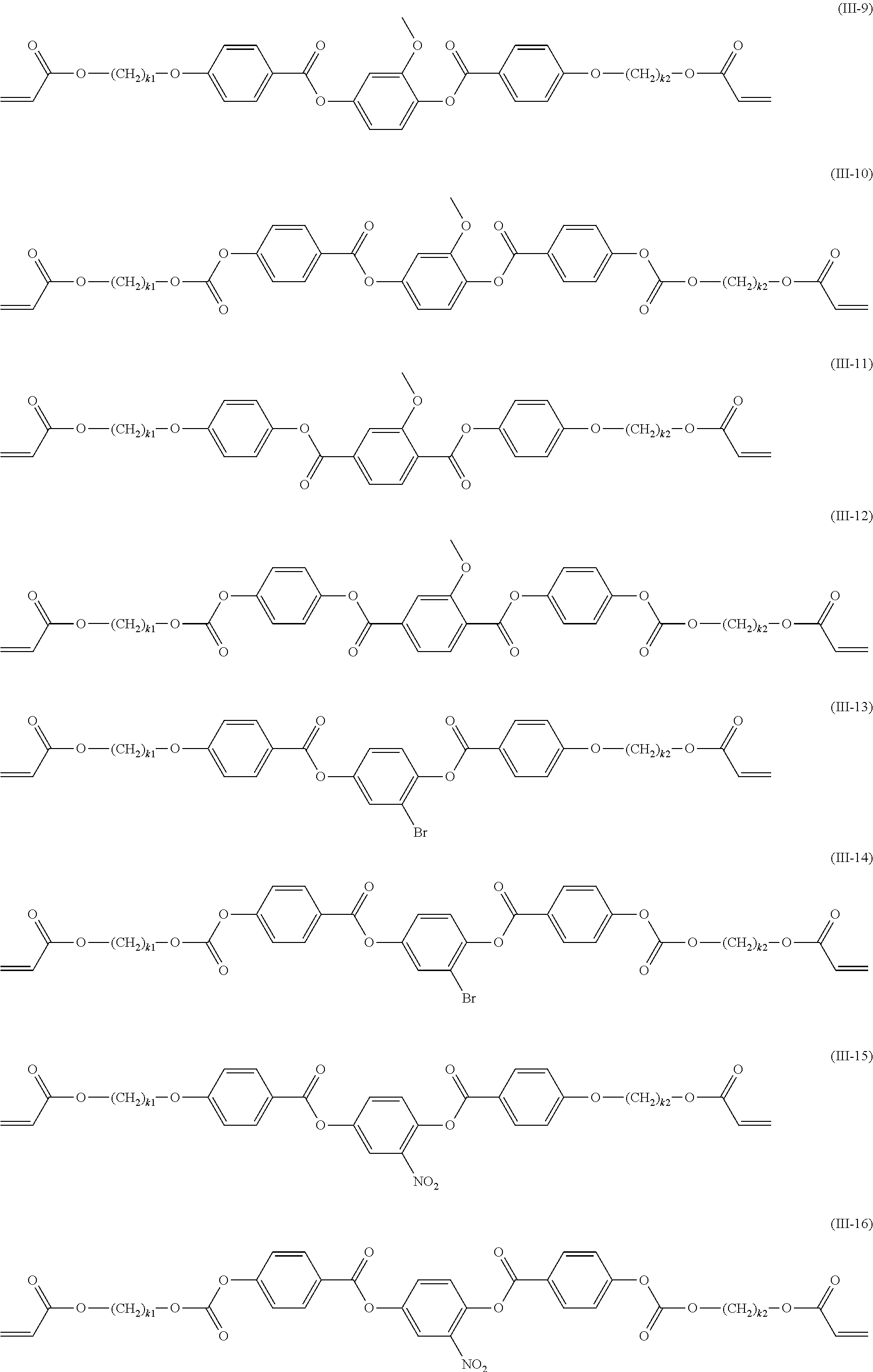

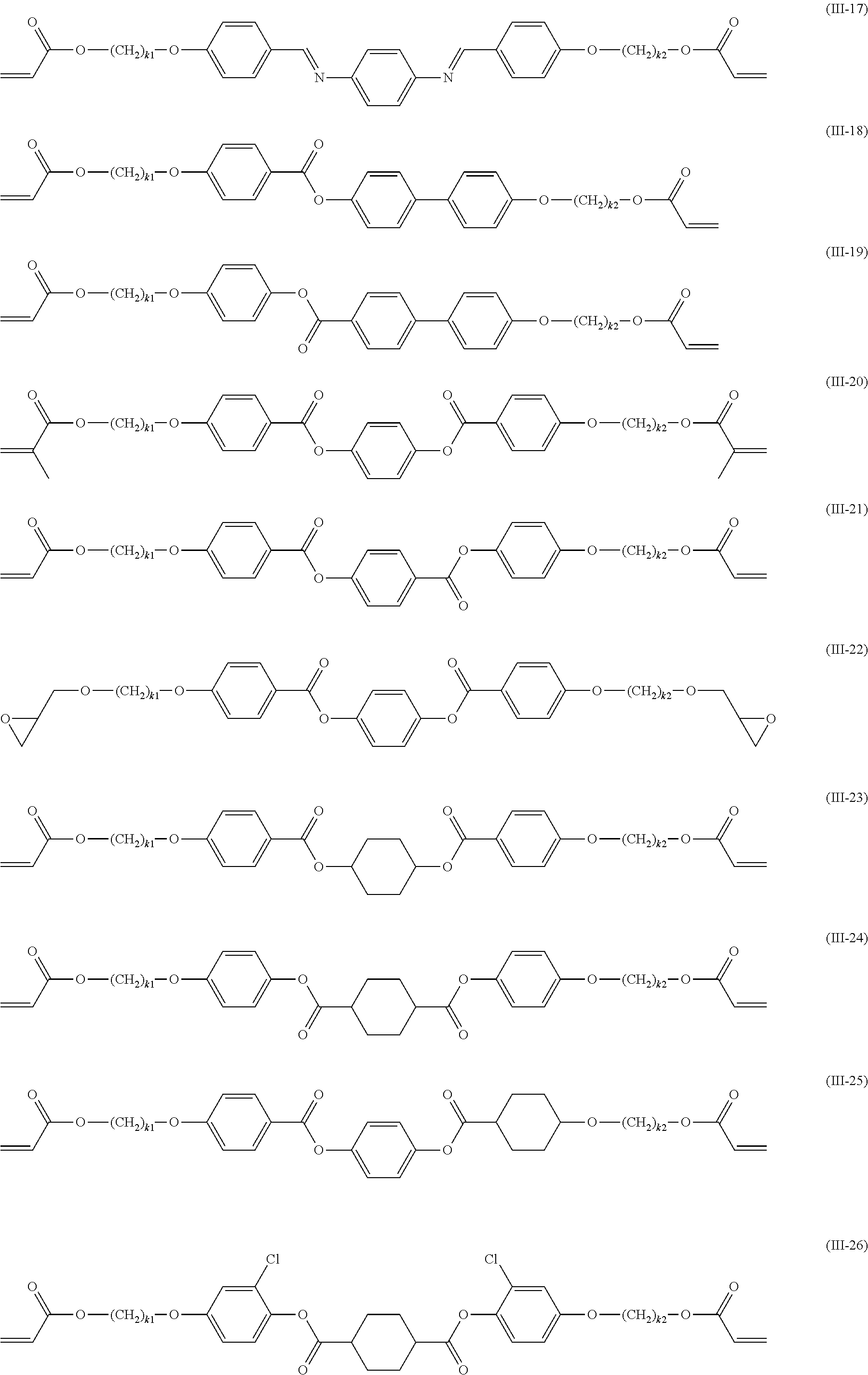

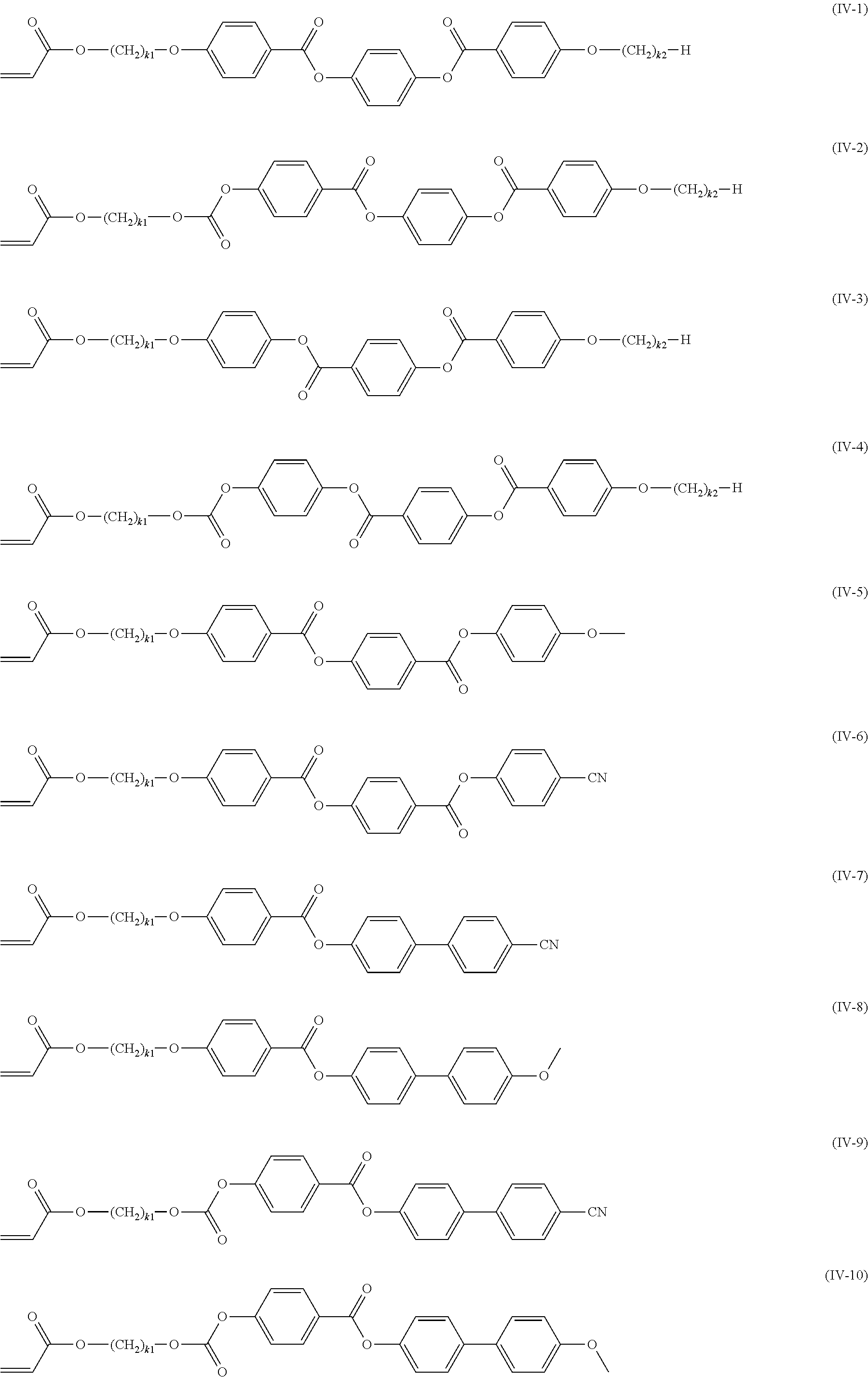

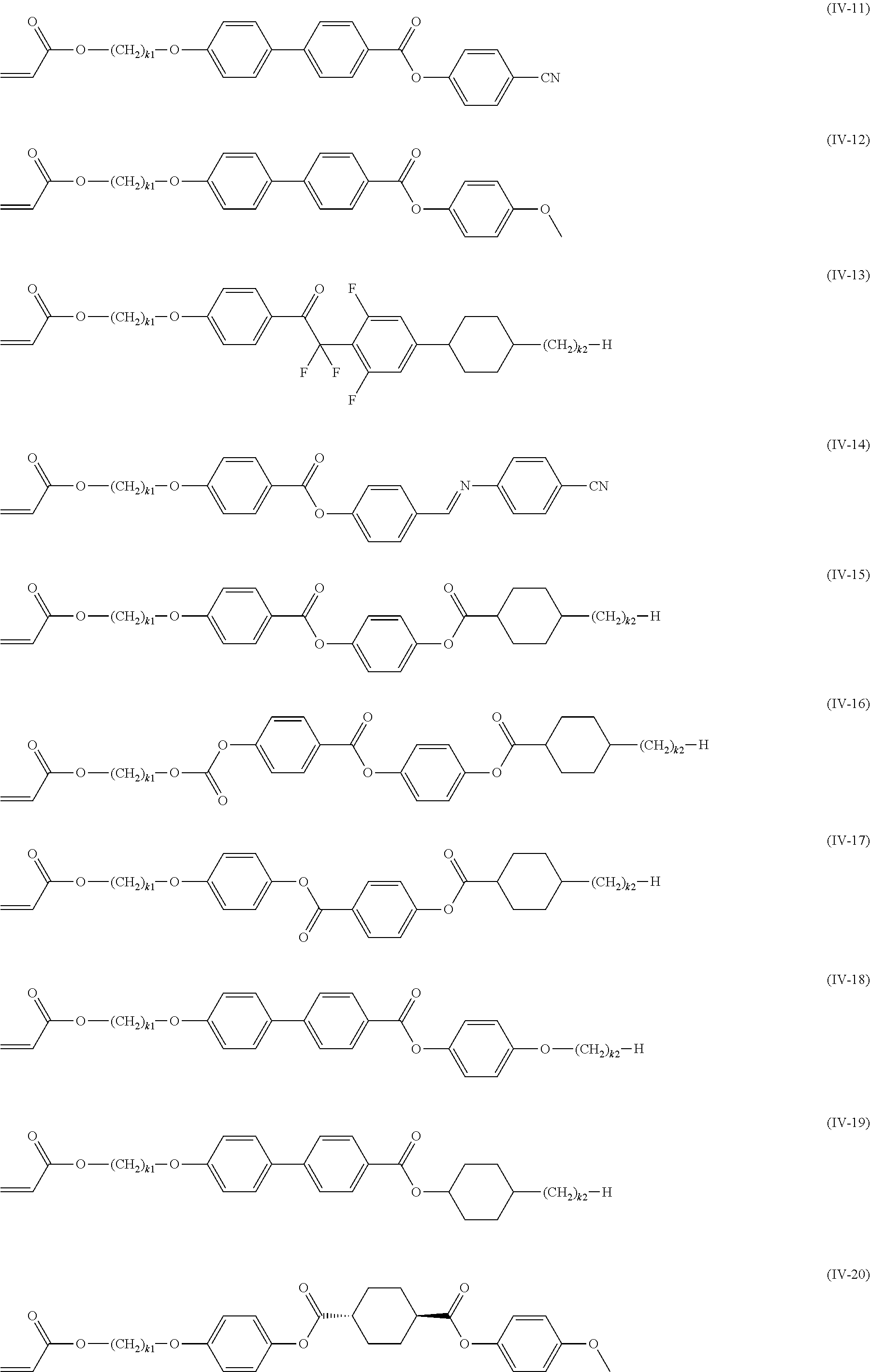

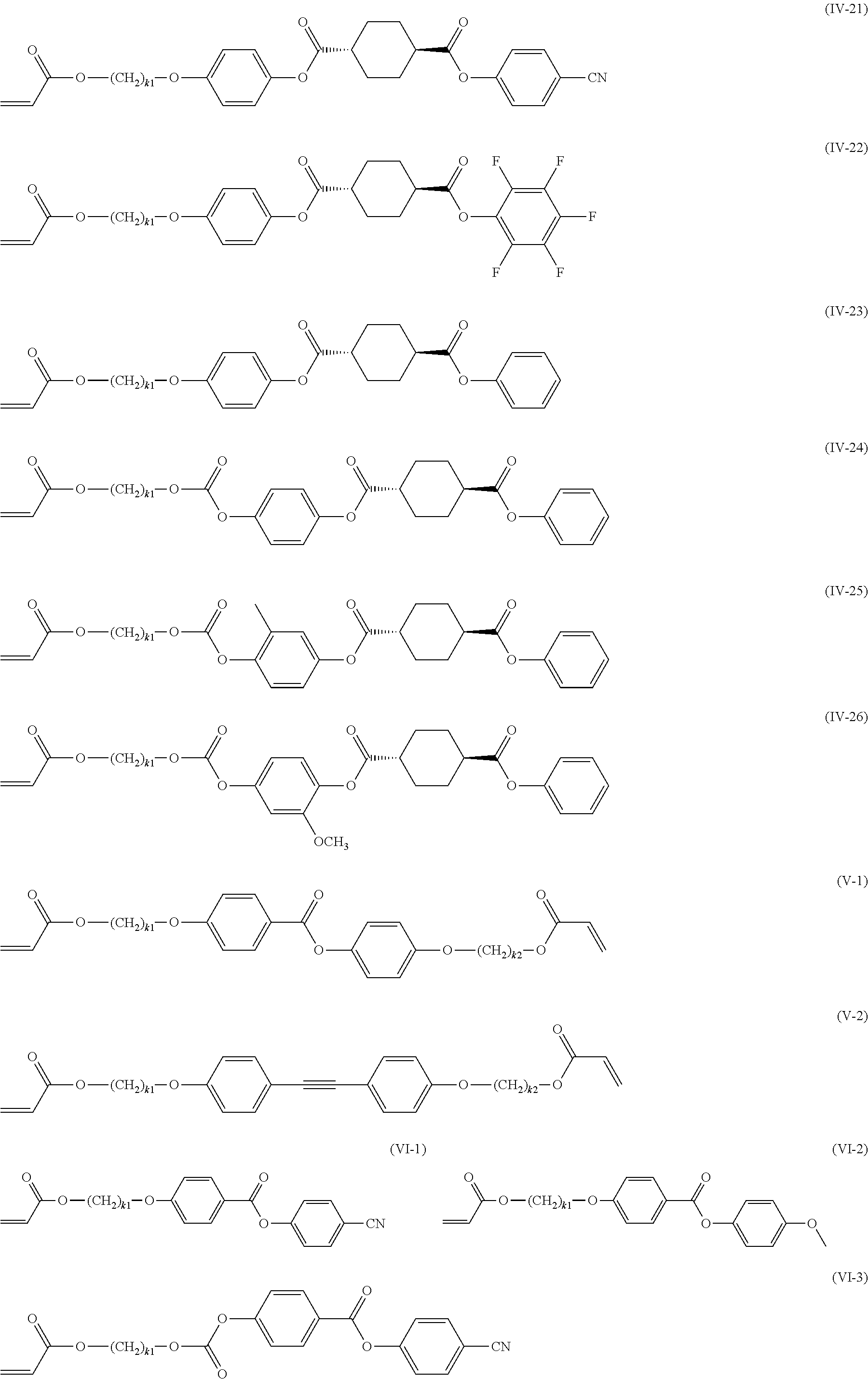

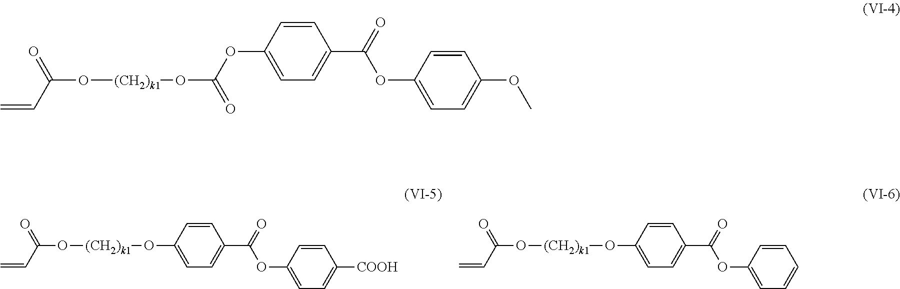

The content of the polymerizable liquid crystal compound in the composition for forming an optically anisotropic layer is usually from 5 parts by mass to 50 parts by mass, and preferably from 10 parts by mass to 30 parts by mass, related to 100 parts by mass of the composition for forming an optically anisotropic layer.

Examples of the photopolymerization initiator include those which generate radicals by photoirradiation.

Examples of the photopolymerization initiator include benzoin compounds, benzophenone compounds, benzyl ketal compounds, α-hydroxyketone compounds, α-aminoketone compounds, α-acetophenone compounds, triazine compounds, iodonium salts and sulfonium salts. Specific examples thereof include IRGACURE 907, IRGACURE 184, IRGACURE 651, IRGACURE 819, IRGACURE 250, and IRGACURE 369 (all manufactured by Ciba Japan K.K.); SEIKUOL BZ, SEIKUOL Z, and SEIKUOL BEE (all manufactured by Seiko Chemical Co., Ltd.); KAYACURE BP100 (manufactured by Nippon Kayaku Co., Ltd.); KAYACURE UVI-6992 (manufactured by the Dow Chemical Company); ADEKA OPTOMER SP-152, and ADEKA OPTOMER SP-170 (all manufactured by Adeka Corporation); TAZ-A and TAZ-PP (all manufactured by Nihon Siber Hegner K.K.), and TAZ-104 (manufactured by Sanwa Chemical Co. Ltd.); and the like. Among them, preferred are α-acetophenone compound's. Examples of the α-acetophenone compounds include 2-methyl-2-morpholino-1-(4-methylsulfanylphenyl)propan-1-on e, 2-dimethylamino-1-(4-morpholinophenyl)-2-benzylbutan-1-one, 2-dimethylamino-1-(4-morpholinophenyl)-2-(4-methylphenylmethyl)butane-1-one, and the like. More preferred are 2-methyl-2-morpholino-1-(4-methylsulfanylphenyl)propane-1-one, and 2-dimethylamino-1-(4-morpholinophenyl)-2-benzylbutan-1-one. Commercially available product examples of the α-acetophenone compounds include IRGACUREs 369, 379EG and 907 (all manufactured by BASF Japan Ltd.), SEIKUOL BEE (manufactured by Seiko Chemical Co., Ltd.), and the like.

The photopolymerization initiator is usually from 0.1 parts by mass to 30 parts by mass, and preferably from 0.5 parts by mass to 10 parts by mass, related to 100 parts by mass of the polymerizable liquid crystal compound. In the above range, the polymerizable liquid crystal compound can be polymerized without disturbing the liquid crystal orientation of the polymerizable liquid crystal compound.

The composition for forming an optically anisotropic layer may further contain a polymerization inhibitor, a photosensitizer, a leveling agent, a chiral agent, a reactive additive, a solvent, and the like.

### [Polymerization Inhibitor]

The polymerization inhibitor can attain the control of the polymerization reaction of the polymerizable liquid crystal compound.

Examples of the polymerization inhibitor include hydroquinone and hydroquinones each having a substituent such as an alkyl ether; catechols each having a substituent such as an alkyl ether, such as butylcatechol; radical scavengers such as pyrogallols and 2,2,6,6-tetramethyl-1-piperidinyloxy radicals; thiophenols; -naphthylamines; and β-naphthols.

The content of the polymerization inhibitor in the composition for forming an optically anisotropic layer is usually from 0.1 parts by mass to 30 parts by mass, and preferably from 0.5 parts by mass to 10 parts by mass, related to 100 parts by mass of the polymerizable liquid crystal compound. In the above range, the polymerizable liquid crystal compound can be polymerized without disturbing the liquid crystal orientation of the polymerizable liquid crystal compound.

### [Photosensitizer]

Examples of the photosensitizer include xanthones such as xanthone and thioxanthone; anthracene, and anthracenes such as anthracene having a substituent such as an alkyl ether; phenothiazine; and rubrene.

The use of the photosensitizer makes it possible to heighten the sensitivity of the photopolymerization initiator. The content of the photosensitizer is usually from 0.1 parts by mass to 30 parts by mass, and preferably from 0.5 parts by mass to 10 parts by mass, related to 100 parts by mass of the polymerizable liquid crystal compound.

### [Leveling Agent]

Examples of the leveling agent include organic modified silicone oil-based, polyacrylate-based, and perfluoroalkyl-based leveling agents. Specific examples thereof include DC3PA, SH7PA, DC11PA, SH28PA, SH29PA, SH30PA, ST80PA, ST86PA, SH8400, SH8700 and FZ2123 (all manufactured by Dow Corning Toray Co., Ltd.); KP321, KP323, KP324, KP326, KP340, KP341, X22-161A and KF6001 (all manufactured by Shin-Etsu Chemical Co., Ltd.); and TSF400, TSF401, TSF410, TSF4300, TSF4440, TSF4445, TSF-4446, TSF4452 and TSF4460 (all manufactured by Momentive Performance Materials Inc.), FLUORINERTs (registered trademark) FC-72, FC-40, FC-43 and FC-3283 (all manufactured by Sumitomo 3M Limited); MEGAFACs (registered trademark) R-08, R-30, R-90, F-410, F-411, F-443, F-445, F-470, F-477, F-479, F-482 and F-483 (all manufactured by DIC Corporation); EFTOPs (trade name) EF301, EF303, EF351 and EF352 (all manufactured by Mitsubishi Materials Electronic Chemicals Co., Ltd.); SURFLONs (registered trademark)S-381, S-382, S-383, S-393, SC-101, SC-105, KH-40 and SA-100 (all manufactured by AGC Seimi Chemical Co., Ltd.); E1830 and E5844 ((trade names) manufactured by Daikin Fine Chemical Laboratory Co., Ltd.); and BM-1000, BM-1100, BYK-352, BYK-353 and BYK-361N ((trade names) manufactured by BM Chemie GmbH). Such leveling agents may be used in any combination of two or more thereof.

It is possible to form a smoother optically anisotropic film by using the leveling agent. Also, it is possible to control the fluidity of the composition for forming an optically anisotropic layer or adjust the crosslinking density of the optically anisotropic film in the production process of the optically anisotropic film. The content of the leveling agent is usually from 0.1 parts by mass to 30 parts by mass, and preferably from 0.1 parts by mass to 10 parts by mass, related to 100 parts by mass of the polymerizable liquid crystal compound.

### [Chiral Agent]

Examples of the chiral agent include known chiral agents (for example, agents described in “Liquid Crystal Device Handbook”, Chapter 3, 4-3, Chiral Agents for TN and STN, p. 199, edited by Japan Society for the Promotion of Science, the 142nd Committee, 1989).

The chiral agent generally contains an asymmetric carbon atom, but an axially asymmetric compound or planarly asymmetric compound, which contains no asymmetric carbon atom, can be also used as the chiral agent. Examples of the axially asymmetric compound or planarly asymmetric compound include binaphthyl, helicene, paracyclophane, and derivatives of these compounds.

Specific examples thereof include compounds as described in JP-A-2007-269640, JP-A-2007-269639, JP-A-2007-176870, JP-A-2003-137887, JP-W-2000-515496, JP-A-2007-169178, and JP-W-09-506088, and preferred is a product Paliocolor (registered trademark) LC756 manufactured by BASF Japan Ltd.

The content of the chiral agent is usually from 0.1 parts by mass to 30 parts by mass, and preferably from 1.0 parts by mass to 25 parts by mass, related to 100 parts by mass of the polymerizable liquid crystal compound. In the above range, when the polymerizable liquid crystal compound is polymerized, disturbance of the liquid crystal orientation of the polymerizable liquid crystal compound can be further suppressed.

### [Reactive Additive]

The reactive additive is preferably a compound having in the molecule thereof a carbon-carbon unsaturated bond and an active hydrogen reactive group. The “active hydrogen reactive group” herein means a group reactive with a group having active hydrogen such as a carboxyl group (—COOH), hydroxyl group (—OH) or amino group (—NH₂). Typical examples thereof are glycidyl, oxazoline, carbodiimide, aziridine, imide, isocyanate, thioisocyanate, maleic anhydride groups, and the like.

It is preferred that the reactive additive has at least two active hydrogen reactive groups. In this case, the active hydrogen reactive groups may be the same as or different from each other.

The carbon-carbon unsaturated bond that the reactive additive has may be a carbon-carbon double bond, a carbon-carbon triple bond, or a combination of the two, and is preferably a carbon-carbon double bond. Among them, it is preferred that a reactive additive contains a carbon-carbon unsaturated bond as a vinyl group and/or a (meth)acrylic group. Furthermore, the reactive additive is preferably a compound having, as its active hydrogen reactive group(s), at least one selected from the group consisting of epoxy, glycidyl and isocyanate groups; and is in particular preferably a reactive additive having an acrylic group and an isocyanate group.

Specific examples of the reactive additive include compounds each having a (meth)acrylic group and an epoxy group, such as methacryloxy glycidyl ether and acryloxy glycidyl ether; compounds each having a (meth)acrylic group and an oxetane group, such as oxetane acrylate and oxetane methacrylate; compounds each having a (meth)acrylic group and a lactone group, such as lactone acrylate and lactone methacrylate; compounds each having a vinyl group and an oxazoline group, such as vinyl oxazoline, and isopropenyl oxazoline; oligomers of a compound having a (meth)acrylic group and an isocyanate group, such as isocyanatomethyl acrylate, isocyanatomethyl methacrylate, 2-isocyanatoethyl acrylate, and 20isocyanatoethyl methacrylate, and the like. Also, other examples thereof include compounds each having a vinyl group or vinylene group and an acid anhydride, such as methacrylic anhydride, acrylic anhydride, maleic anhydride, and vinylmaleic anhydride, and the like. Among them, preferred are methacryloxy glycidyl ether, acryloxy glycidyl ether, isocyanatomethyl acrylate, isocyanatomethyl methacrylate, vinyl oxazoline, 2-isocyanatoethyl acrylate, 2-isocyanatoethyl methacrylate, and the above-mentioned oligomers. Particularly preferred are isocyanatomethyl acrylate, 2-isocyanatoethyl acrylate, and the above-mentioned oligomers.

Here, those having an isocyanate group as the active hydrogen reactive group that are more preferred as the reactive additive are specifically shown. For example, such a preferred reactive additive is represented by the following formula (Y):

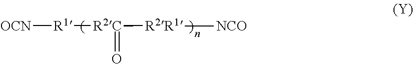

wherein

n represents an integer of 1 to 10, R¹'s each represent a bivalent aliphatic or alicyclic hydrocarbon group having 2 to 20 carbon atoms, or a bivalent aromatic hydrocarbon group having 5 to 20 carbon atoms; and one of two R²'s in each of the recurring units is a group represented by —NH— and the other is a group represented by >N—C(═O)—R^{3′} wherein R^{3′} represents a hydroxyl group or a group having a carbon-carbon unsaturated bond.

At least one of R³'s in the formula (Y) is a group having a carbon-carbon unsaturated bond.

Of the reactive additives represented by the formula (Y), particularly preferred is a compound represented by the following formula (YY) in which n has the same meaning as described above (hereinafter the compound may be referred to as the “compound (YY)”).

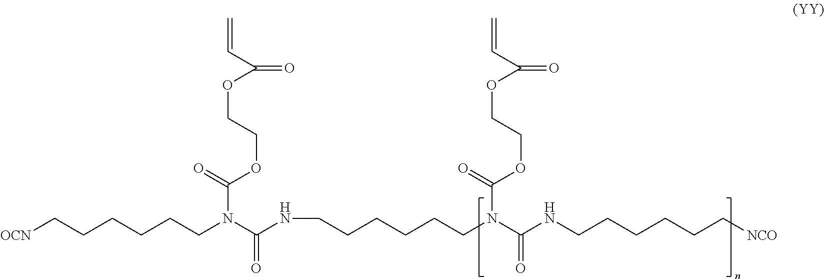

As the compound (YY), a commercially available product is usable as it is, or after being purified if necessary. Examples of the commercially available product include Laromer (registered trademark) LR-9000 (manufactured by BASF) and the like.

The content of the reactive additive is usually from 0.1 parts by mass to 30 parts by mass, preferably from 0.1 parts by mass to 5 parts by mass, related to 100 parts by mass of the polymerizable liquid crystal compound.

### [Solvent]

It is preferred that the composition for forming an optically anisotropic layer contains a solvent, particularly an organic solvent, in order to improve operability of production of the optically anisotropic film. The organic solvent is preferably an organic solvent in which constituent components of the composition for forming an optically anisotropic layer such as the polymerizable liquid crystal compound are soluble, and is more preferably a solvent in which constituent components of the composition for forming an optically anisotropic layer such as the polymerizable liquid crystal compound are soluble, that is inert to the polymerization reaction of the polymerizable liquid crystal compound. Specific examples thereof include alcohol solvents such as methanol, ethanol, ethylene glycol, isopropyl alcohol, propylene glycol, methylcellosolve, butylcellosolve, propylene glycol monomethyl ether, and phenol; ester solvents such as ethyl acetate, butyl acetate, ethylene glycol methyl ether acetate, α-butyrolactone, propylene glycol methyl ether acetate, and ethyl lactate; ketone solvents such as acetone, methyl ethyl ketone, cyclopentanone, cyclohexanone, methyl amyl ketone, and methyl isobutyl ketone; non-chlorinated aliphatic hydrocarbon solvents such as pentane, hexane, and heptane; non-chlorinated aromatic hydrocarbon solvents such as toluene and xylene; nitrile solvents such as acetonitrile; ether solvents such as tetrahydrofuran and dimethoxyethane; and chlorinated hydrocarbon solvents such as chloroform and chlorobenzene. Such organic solvents may be used in combination of two or more thereof. Among them, preferred are alcohol solvents, ester solvents, ketone solvents, non-chlorinated aliphatic hydrocarbon solvents, and non-chlorinated aromatic hydrocarbon solvents.

Examples of the state of the liquid crystal orientation of the polymerizable liquid crystal compound include horizontal orientation, vertical orientation, hybrid orientation, oblique orientation, and the like. Preferred is vertical orientation. The expressions “horizontal”, “vertical” and the like each represent the orientation direction of a long axis of the polymerizable liquid crystal compound, based on the substrate surface. For example, the “vertical orientation” denotes that the polymerizable liquid crystal compound has a long axis along a direction vertical to the substrate surface.

A vertically oriented polymerizable liquid crystal compound is likely to distribute a polymerizable group near the interface between the composition for forming an optically anisotropic layer and atmosphere, thus the polymerization reaction of the polymerizable liquid crystal compound tends to be strongly influenced by the atmospheric environment. Accordingly, among the optically anisotropic films produced by the production method of the present invention, one obtained by irradiating the composition for forming an optically anisotropic layer containing a vertically oriented polymerizable liquid crystal compound with light more strongly exhibits the effect of the present invention, thus shows more excellent transparency and durability of optical anisotropy as compared to the conventional articles.

The state of the liquid crystal orientation varies depending on the characteristic of the orientation layer and the polymerizable liquid crystal compound, and the combination thereof can be arbitrarily selected. When the orientation layer is made of, for example, a material expressing horizontal orientation as orientation regulating force, the polymerizable liquid crystal compound can form horizontal orientation or hybrid orientation. When the orientation layer is made of a material expressing vertical orientation, the polymerizable liquid crystal compound can form vertical orientation or oblique orientation.

When the orientation layer is composed of an orienting polymer, the orientation regulating force is optionally adjustable in accordance with the surface state or rubbing conditions. When the orientation layer is composed of a photo-orienting polymer, the orientation regulating force is optionally adjustable in accordance with polarized-light-irradiating conditions and the like. The liquid crystal orientation is also controllable by selecting physical properties such as surface tension and liquid crystal property of the polymerizable liquid crystal compound.

When the polymerizable liquid crystal compound contained in the composition for forming an optically anisotropic layer coated onto the orientation layer exhibits a liquid crystal phase such as a nematic phase, the film has a birefringence property based on mono-domain orientation.

Examples of the method for coating the composition for forming an optically anisotropic layer onto the orientation layer include extrusion coating, direct gravure coating, reverse gravure coating, CAP coating, slit coating, die coating methods, and the like. Also, examples include a method of coating using a coater such as a dip coater, a bar coater or a spin coater, and the like. Among them, preferred are CAP coating, inkjet coating, dip coating, slit coating, die coating, and bar-coater-used coating methods, since these methods make it possible to attain the coating continuously in a roll-to-roll manner. When this composition is coated in a roll-to-roll manner, it is allowable to form an orientation layer by coating a composition containing orienting polymer onto the substrate, and further form the optically anisotropic film continuously on the obtained orientation layer.

An optically anisotropic film is obtained by irradiating the coated composition for forming an optically anisotropic layer with light to polymerize a polymerizable liquid crystal compound. The photoirradiation is performed while keeping the coated composition for forming an optically anisotropic layer warm at a liquid crystal-liquid phase transition temperature of the polymerizable liquid crystal compound or less, in an atmosphere of 0.5% or less of oxygen concentration.

The oxygen concentration during photoirradiation is preferably 0.5% or less, more preferably 0.2% or less, and further preferably 0.1% or less. When the oxygen concentration during photoirradiation is high, the polymerization reaction of the polymerizable liquid crystal compound tends to be inhibited. When the oxygen concentration during photoirradiation is within the range as described above, the polymerization reaction of the polymerizable liquid crystal compound proceeds sufficiently, and durability of the optically anisotropic film tends to be improved. In addition, durability of the optically anisotropic film is improved, whereby performance change over time when mounted on a display device can be suppressed.

The air pressure during photoirradiation is usually an atmospheric pressure.

As a method for making the oxygen concentration during photoirradiation of an atmosphere at 0.5% or less, a method of allowing nitrogen to flow between a photoirradiation device and the composition for forming an optically anisotropic layer as a single space is preferred. When an optically anisotropic film is produced in a roll-to-roll manner, it is advisable to bring a backup roll used for transporting an optically anisotropic film close to the photoirradiation device, and design so as to supply and exhaust nitrogen with an interval for transporting the film. The present method is merely an example, and it is also possible to use other general nitrogen supply method.

The temperature of the surface of the substrate during photoirradiation is preferably a liquid crystal-liquid phase transition temperature of the polymerizable liquid crystal compound or less. The polymerizable liquid crystal compound becomes a liquid state at a liquid crystal-liquid phase transition temperature or more, thus cannot exhibit anisotropy.

In the temperature range of the liquid crystal-liquid phase transition temperature or less, the temperature of the substrate surface is preferably 80° C. or less, more preferably 70° C. or less, and further preferably 60° C. or less. Also, the temperature is preferably 30° C. or more, more preferably 40° C. or more, and further preferably 50° C. or more. A temperature during photoirradiation at 80° C. or less is preferred since fluctuation in the liquid crystal orientation is suppressed thus the defects are hard to occur, and thermal influence on the substrate can be also suppressed. Examples of the method for keeping at the temperature include a method of pouring an air and nitrogen for ventilation during photoirradiation, a method of allowing a refrigerant to flow into the backup roll, thereby cooling the surface on the opposite side of the substrate surface on which the orientation layer is formed, and the like. Among them, it is preferred to perform photoirradiation by bringing the surface on the opposite side of the substrate surface on which the orientation layer of the substrate is formed into contact with a refrigerant circulation roll that is a backup roll into which a refrigerant can be allowed to flow. The optically anisotropic film obtained by the above method is excellent in transparency, and light leakage when mounted on a display device can be suppressed.

The temperature of a refrigerant flowed through the refrigerant circulation roll is usually 4° C. to 30° C. Specifically, as the refrigerant, a general medium such as water at 20° C. to 30° C. or a refrigerant at 4° C. to 10° C. can be used.

The time for bringing the surface on the opposite side of the substrate surface on which the orientation layer is formed into contact with the refrigerant circulation roll is usually 5 seconds to 10 minutes, preferably 5 seconds to 2 minutes, more preferably 5 seconds to 1 minute, and further preferably 5 seconds to 30 seconds.

The time for irradiating light is usually 5 seconds to 10 minutes, preferably 5 seconds to 2 minutes, more preferably 5 seconds to 1 minute, and further preferably 5 seconds to 30 seconds. In the above range, an optical film excellent in transparency can be obtained.

Examples of the photoirradiation unit include a mechanism as illustrated in FIG. 3 as an example. A film 11 in which the composition for forming an optically anisotropic layer is coated onto the surface of the orientation layer is transported in the direction of the arrows in FIG. 3. During photoirradiation, the film was transported while being brought into contact with a backup roll 12. The surface onto which the composition for forming an optically anisotropic layer is coated is a surface on the opposite side of the surface in contact with the backup roll 12 of the substrate, and is a surface of a lamp house 13. A refrigerant is circulated into the backup roll 12, whereby the backup roll 12 can be served as a refrigerant circulation roll, and cool the substrate during photoirradiation.

The photoirradiation is usually performed by visible rays, ultraviolet rays, or a laser ray, and preferred is ultraviolet rays.

The photoirradiation is performed by bringing a lamp house 13 close to the backup roll 12, as shown in FIG. 3. A lamp 14 is set in the lamp house 13, and the distance between the lamp 14 and the film 11 is adjusted, whereby illuminance can be controlled. The arrows 15 in FIG. 3 stand for light. The distance between the lamp house 13 and the backup roll 12 is not particularly limited, and the distance such that nitrogen exceeding the supply and exhaust air quantities in the lamp house 13 does not leak without bringing the lamp house 13 into contact with the coating surface is preferred.

The photoirradiation may be directly performed to the coated composition for forming an optically anisotropic layer, and when the composition for forming an optically anisotropic layer contains the solvent, the photoirradiation is preferably performed after the solvent is dried to be removed. A polymerizable liquid crystal compound contained in the composition for forming an optically anisotropic layer forms liquid crystal orientation by removing the solvent from the coated composition for forming an optically anisotropic layer. The drying (removal of the solvent) may be performed simultaneously with the photoirradiation. It is however preferred to remove almost all of the solvent before performing photoirradiation. Examples of the drying method include the same method as the drying method in forming the orientation layer. Among them, preferred are natural drying and heat drying. The drying temperature is preferably in the range of 0° C. to 250° C., more preferably in the range of 50° C. to 220° C., and further preferably in the range of 60° C. to 170° C. The drying time is preferably from 10 seconds to 60 minutes, and more preferably from 30 seconds to 30 minutes.

In the production method of the present invention, it is preferred that the following steps (1), (2) and (3) are continuously performed to a rolled substrate, and more preferred that the following steps (1), (2), (2-2) and (3) are continuously performed:

(1) a step of forming an orientation layer on a rolled substrate;
(2) a step of coating a composition for forming an optically anisotropic layer containing a polymerizable liquid crystal compound and a photopolymerization initiator onto the surface of the formed orientation layer;
(2-2) a step of drying the coated composition for forming an optically anisotropic layer to liquid-crystal-orient the polymerizable liquid crystal compound; and
(3) a step of irradiating the coated or dried composition for forming an optically anisotropic layer with light in an atmosphere of 0.5% or less of oxygen concentration, while keeping the composition for forming an optically anisotropic layer at a liquid crystal-liquid phase transition temperature of the polymerizable liquid crystal compound or less.

The thickness of the optically anisotropic film thus obtained can be properly adjusted depending on its use, and is preferably from 0.1 μm to 10 μm, and further preferably from 0.2 μm to 5 μm to reduce photoelasticity.

When the optically anisotropic film manufactured by the production method of the present invention (hereinafter, may be referred to as the present optically anisotropic film) is formed on the surface of the orientation layer formed on the surface of the substrate, the optically anisotropic film may be used as it is, and may be used after removing the substrate, or the substrate and the orientation layer.

The present optically anisotropic film not having the substrate, or the substrate and the orientation layer, is usually combined with other member such as a polarization film via an adhesive.

Examples of the method for combining with other member via an adhesive include a method of bonding the optically anisotropic film not having the substrate, or the substrate and the orientation layer, onto other member using an adhesive; a method of bonding the optically anisotropic film formed on the surface of the orientation layer formed on the surface of the substrate, onto other member using an adhesive, then removing the substrate, or the substrate and the orientation layer; and the like. At this time, the adhesive may be coated onto the present optically anisotropic film, and may be coated onto other member.

Among the present optically anisotropic films, a film in which a polymerizable liquid crystal compound is vertically oriented is useful as a retardation film used for converting a linearly polarized light when confirming from the oblique angle of a light emission side to a circularly polarizing light or an elliptically polarizing light, converting a circularly polarizing light or an elliptically polarizing light to a linearly polarized light, and converting the polarization direction of a linearly polarized light.

The retardation film is excellent in transparency in a visible light region, and can be used as a member for various display devices.

The present optically anisotropic film may be laminated in a plural number, and may be combined with other film. When the present optically anisotropic film with different orientation states of the polymerizable liquid crystal compound is laminated in a plural number, or the present optically anisotropic film is combined with other film, the laminated body can be used as a viewing angle compensating film, a viewing angle enlarging film, an anti-reflection film, a polarizing plate, a circularly polarizing plate, an elliptically polarizing plate, or a brightness enhancement film.

The present optically anisotropic film can be changed in optical property in accordance with the orientation state of the polymerizable liquid crystal compound, and is usable as a retardation film for various liquid crystal display devices in a vertical alignment (VA) mode, an in-plane switching (IPS) mode, an optically compensated bend (OCB) mode, a twisted nematic (TN) mode, a super twisted nematic (STN) mode, and the like.

When the refractive index in the in-plane slow axis direction thereof is represented by nₓ, that in the direction orthogonal to the in-plane slow axis (the fast axis direction) by n_{y}, and that in the thickness direction thereof by n_{z}, the optically anisotropic films can be classified as follows. The present optically anisotropic film is particularly preferably used as a positive C plate.

a positive A plate in which nₓ>n_{y}≈n_{z},
a negative C plate in which nₓ≈n_{y}>n_{z},
a positive C plate in which nₓ≈n_{y}<n_{z}, and
a positive O plate and a negative O plate in which nₓ≠n_{y}≠n_{z}

When the present optically anisotropic film is used as a positive C plate, it is advisable to adjust the front retardation value Re(549) into the range of 0 nm to 10 nm, and preferably usually into that of 0 nm to 5 nm, and adjust the retardation value Rₜₕ in thickness direction usually into the range of −10 nm to −300 nm, and preferably into that of −20 nm to −200 nm. The front retardation value Re(549) is preferably properly selected in accordance with properties of a liquid crystal cell, and is particularly suitable for compensation for liquid crystal display devices in an IPS mode.

The retardation value Rₜₕ in thickness direction, which means the refractive index anisotropy of the optically anisotropic film in the thickness direction, can be calculated from the retardation value R₅₀ measured in the state of inclining the in-plane fast axis at 50 degrees to be rendered an inclined axis, and the in-plane retardation value R₀. Specifically, the retardation value Rₜₕ in thickness direction can be calculated by obtaining nₓ, n_{y} and n_{z} through the following equations (9) to (11), from the in-plane retardation value R₀, the retardation value R₅₀, which is measured in the state of inclining the fast axis at 50 degrees to be rendered an inclined axis, the thickness d of the film, and the average refractive index n₀ of the film; and then substituting these values into an equation (8).

Rₜₕ=[(nₓ+n_{y})/2−n_{z}]×d (8)

R₀=(nₓ−n_{y})×d (9)

R₅₀=(nₓ−n_{y}′)×d/cos(φ) (10)

(nₓ+n_{y}+n_{z})=n₀ (11)

wherein

φ=sin⁻¹[sin(50°)/n₀]

n_{y}′=n_{y}×n_{z}/[n_{y}²×sin²(φ)+n_{z}²×cos²(φ)]^{1/2}

Here, the present optically anisotropic film suppresses occurrence of an orientation defect. When orientation defects frequently occur, uniformity of the surface of the liquid crystal layer is degraded, thus scattering is caused, and the haze value is increased. However, in the present invention, a film with high transparency with a haze suppressed to 1% or less can be obtained. The haze value can be measured using a commercially available haze meter, for example, a haze meter (model: HZ-2) manufactured by Suga Test Instruments Co., Ltd. or the like can be used.

The present optically anisotropic film is also useful as a member which constitutes a polarizing plate. The polarizing plate of the present invention is a plate containing at least one of the present optically anisotropic films, and may be contained as a retardation film.

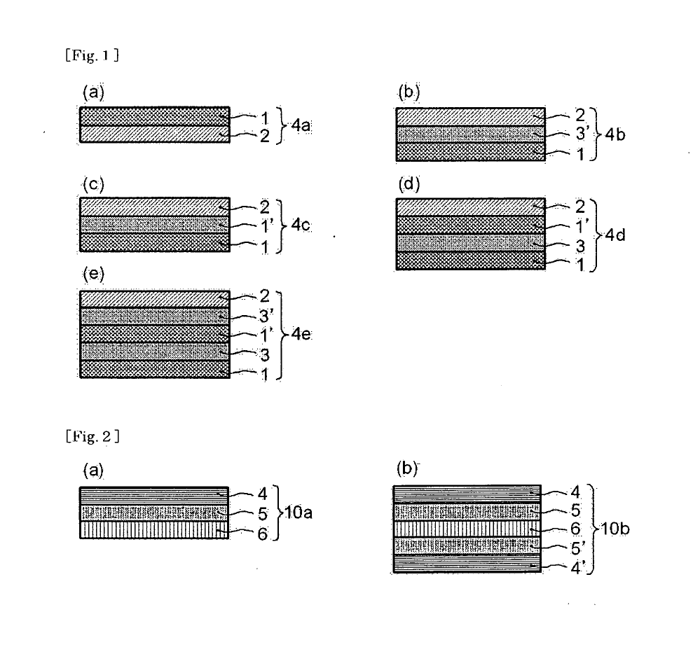

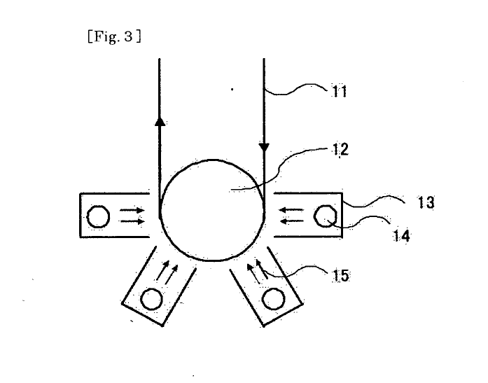

Specific examples of the polarizing plate include polarizing plates illustrated in FIGS. 1(a) to 1(e). The polarizing plate 4a illustrated in FIG. 1(a) is a polarizing plate in which a retardation film 1 and a polarization film 2 are laminated directly onto each other. The polarizing plate 4b illustrated in FIG. 1(b) is a polarizing plate in which a retardation film 1 and a polarization film 2 are bonded onto each other through an adhesive layer 3′. The polarizing plate 4c illustrated in FIG. 1(c) is a polarizing plate in which retardation films 1 and 1′ are laminated onto each other and further a polarization film 2 is laminated onto the retardation film 1′. The polarizing plate 4d illustrated in FIG. 1(d) is a polarizing plate in which retardation films 1 and 1′ are bonded onto each other through an adhesive layer 3, and further a polarization film 2 is laminated onto the retardation film 1′. The polarizing plate 4e illustrated in FIG. 1(e) is a polarizing plate in which retardation films 1 and 1′ are bonded onto each other through an adhesive layer 3, and further the retardation film 1′ and a polarization film 2 are bonded onto each other through an adhesive layer 3′. The “adhesive” is a generic name of any adhesive and/or any pressure-sensitive adhesive.

The retardation film and polarization film may have or may not have a substrate.

It is sufficient for the polarization film 2 to be a film having a polarizing function. Examples of the film include a drawn film to which a dye having absorption anisotropy is adsorbed, a film to which a dye having absorption anisotropy is coated, and the like. Examples of the dye having absorption anisotropy include dichroic dyes such as iodine and azo compounds.

Examples of the drawn film to which a dye having absorption anisotropy is adsorbed include a film obtained by adsorbing a dichroic dye to a polyvinyl alcohol-based film, and then drawing the resultant; a film obtained by drawing a polyvinyl alcohol-based film, and then adsorbing a dichroic dye to the resultant; and the like.

Examples of the film to which a dye having absorption anisotropy is coated include a film obtained by coating a composition containing a dichroic dye having liquid crystal property, or coating a composition containing a dichroic dye and a polymerizable liquid crystal compound, and the like.

The film having a polarizing function preferably has a protection film on one surface or both surfaces thereof. Examples of the protection film include those identical to the above-mentioned substrate.

Specific examples of the drawn film to which a dye having the absorption anisotropy is adsorbed include polarizing plates described in Japanese Patent Nos. 3708062 and 4432487.

Specific examples of the film to which a dye having absorption anisotropy is coated include polarization films described in JP-A-2012-33249 and the like.

The adhesive that forms the adhesive layers 3 and 3′ is preferably an adhesive with high transparency and excellent heat resistance. Examples of such adhesive include acrylic-based, epoxy-based and urethane-based adhesives.

The degree of polarization of the polarizing plate having the present optically anisotropic film is usually 99.9% or more, and preferably 99.97% or more.

The present optically anisotropic film is usable in a display device. Examples of the display device include a liquid crystal display device having a liquid crystal panel in which the present optically anisotropic film is stacked on a liquid crystal panel. A liquid crystal display device will be described as an embodiment of the display device including the present optically anisotropic film.

Examples of the liquid crystal display device include liquid crystal display devices 10a and 10b illustrated in FIGS. 2(a) and 2(b), respectively. In the liquid crystal display device 10a illustrated in FIG. 2(a), the polarizing plate 4 of the present invention and a liquid crystal panel 6 are bonded through an adhesion layer 5. In the liquid crystal display device 10b illustrated in FIG. 2(b), the polarizing plate 4 of the present invention is bonded to one surface of a liquid crystal panel 6 through an adhesion layer 5 while a polarizing plate 4′ of the present invention is bonded to the other surface of the liquid crystal panel 6 through an adhesion layer 5′. Electrodes not illustrated are used in these liquid crystal display devices to apply a voltage to their liquid crystal panel to change the liquid crystal orientation of liquid crystal molecules. In this way, a monochrome display can be realized.

### Examples

Hereinafter, the present invention will be more specifically described by way of examples. In the examples, the symbol “%” and the word “part(s)” denote “% by mass” and “part(s) by mass”, respectively, unless otherwise specified.

### [Preparation of Composition for Orientation Layer]

Composition of a composition for an orientation layer is shown in Table 1. N-methyl-2-pyrrolidone, 2-butoxyethanol and ethylcyclohexane were added to a commercially available orienting polymer, SUNEVER SE-610 (manufactured by Nissan Chemical Industries, Ltd.) to yield a composition for an orientation layer (A).

TABLE 1

| | Solid | | | |
|---|---|---|---|---|
| | content of | N-methyl-2- | | Additive |
| | SE-610 | pyrrolidone | 2-Butoxyethanol | solvent |
| Composition | 0.26 g | 36.8 g | 9.2 g | Ethyl- |
| for | (0.5%) | (72.3%) | (18.1%) | cyclohexane |
| orientation | | | | 4.6 g (9.1%) |
| layer | | | | |

The value in parentheses in Table 1 represents the proportion of the content of each component in the total amount of the prepared composition. About the SE-610, the solid content was obtained by conversion from the concentration described in a delivery specification thereof.

### [Preparation of Composition for Forming an Optically Anisotropic Layer]

Composition of a composition for forming an optically anisotropic layer is shown in Table 2. The individual components were mixed, and the resultant solution was stirred at 80° C. for 1 hour, and then cooled to room temperature to yield a composition for forming an optically anisotropic layer (B). Polymerizable liquid crystal compound (X-1) was produced by the method described in JP-A-2010-1284.

TABLE 2

| | Polymerizable | | | | |
|---|---|---|---|---|---|
| | liquid crystal | Photopolymerization | Leveling | Reactive | |
| | compound | initiator | agent | additive | Solvent |
| Composition for | X-1 | Irg907 | BYK-361N | LR-9000 | PGMEA |
| forming | (19.2%) | (0.6%) | (0.1%) | (1.1%) | (79.0%) |
| optically | | | | | |
| anisotropic | | | | | |
| layer | | | | | |

The value in parentheses in Table 2 represents the proportion of the content of each component in the total amount of the prepared composition.

In Table 2, LR-9000 represents Laromer (registered trademark) LR-9000 manufactured by BASF Japan Ltd.; Irg907 represents IRGACURE 907 manufactured by BASF Japan Ltd.; BYK361N represents a leveling agent manufactured by BYK Japan K.K.; X-1 represents a liquid crystal compound manufactured by BASF represented by the following formula; and PGMEGA represents propylene glycol 1-monomethyl ether 2-acetate.

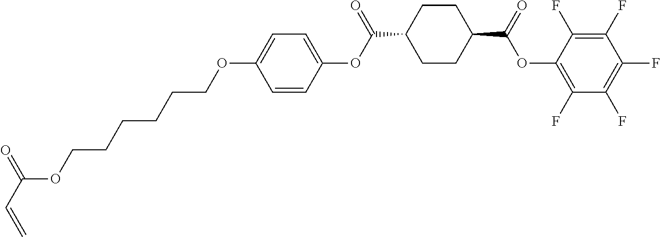 [SMILES: C=CC(=O)OCCCCCCOc1ccc(OC(=O)[C@H]2CC[C@H](C(=O)Oc3c(F)c(F)c(F)c(F)c3F)CC2)cc1]

### Polymerizable Liquid Crystal Compound (X-1)

### [Measurement of Liquid Crystal-Liquid Phase Transition Temperature of Polymerizable Liquid Crystal Compound (X-1)]

The polymerizable liquid crystal compound (X-1) was observed while heated at a heating rate of 30° C./min using a polarizing microscope with a hot stage (hot stage: LTS350 manufactured by Linkam Scientific Instruments Ltd., polarizing microscope: BX-51 manufactured by Olympus Corporation). The polymerizable liquid crystal compound (X-1) changes its phase to a smectic phase at 69° C., to a nematic phase at 79° C., and to a liquid at 89° C.

### Example 1

### Production Example 1 of Optically Anisotropic Film

The surface of a cycloolefin polymer film (ZF-14, manufactured by Zeon Corporation) was once treated using a corona treating apparatus (AGF-B10, manufactured by Kasuga Electric Works Ltd.) at a power of 0.3 kW and a treating rate of 3 m/minute.

The composition for an orientation layer (A) was coated onto the surface of a cycloolefin polymer film obtained by applying a corona treatment, and dried, to form an orientation layer having a thickness of 50 nm. Subsequently, the composition for forming an optically anisotropic layer (B) was coated onto the surface of the orientation layer using a bar coater. The resultant workpiece was heated to 100° C., dried, and cooled to room temperature. The surface on which an orientation layer of the resultant film was not formed was brought into contact with a hot plate at 70° C., and the atmospheric oxygen concentration was set to 900 ppm. Polymerization was carried out by irradiating light with a wavelength of 365 nm at an illuminance of 40 mW/cm² for 30 seconds, using Unicure (VB-15201BY-A, manufactured by USHIO INC.), to prepare an optically anisotropic film (1). The film thickness of the optically anisotropic layer was measured using a laser microscope (LEXT3000, manufactured by Olympus Corporation) and found to be 1.5 μm.

### Comparative Example 1

### Production Example 1 of Comparison Optically Anisotropic Film

A comparison optically anisotropic film 1 was yielded in the same conditions as in Example 1 except that the temperature of the hot plate was changed to 100° C. in Example 1. The film thickness of the optically anisotropic layer was measured using a laser microscope (LEXT3000, manufactured by Olympus Corporation) and found to be 1.5 μm.

### Comparative Example 2

### Production Example 2 of Comparison Optically Anisotropic Film

A comparison optically anisotropic film 2 was yielded in the same conditions as in Example 1 except that the atmospheric oxygen concentration during photoirradiation was changed to 10000 ppm in Example 1. The film thickness of the optically anisotropic layer was measured using a laser microscope (LEXT3000, manufactured by Olympus Corporation) and found to be 1.5 μm.

### [Transparency Evaluation]

A haze meter (model: HZ-2) manufactured by Suga Test Instruments Co., Ltd. was used to measure the haze value of the optically anisotropic film 1 and the comparison optically anisotropic films 1 and 2, using a double beam method. The results are shown in Table 3.

### [Optical Property Measurement]

The retardation value of the optically anisotropic film 1 and the comparison optically anisotropic films 1 and 2 was measured using a measuring instrument (KOBRA-WR, manufactured by Oji Scientific Instruments).

The measurement was made while the incident angle of light into the sample was varied, and it was checked whether or not its liquid crystal was vertically oriented. The results are shown in Table 3.

Also, the retardation value R0(λ) at an incident angle of 0 (front) and the retardation value R50(λ) at an incident angle of 50 (inclination around the fast axis) were each measured at a wavelength (λ) of 549 nm. The results are shown in Table 4.

Using the resultant retardation values R0(549) and R50(549), the refractive indexes nₓ, n_{y} and n_{z} of the optically anisotropic film were calculated through the above equations (9) to (11). The average refractive index n₀ was defined as 1.6. The results are shown in Table 5.

### [Measurement of Degree of Polarization]

A polarizing plate (iodine-containing ordinary polarizing plates, TRW842AP7, manufactured by Sumitomo Chemical Co., Ltd.) was bonded onto the optically anisotropic film 1 and the comparison optically anisotropic films 1 and 2, using a pressure-sensitive adhesive. The degree of polarization of the polarizing plate with an optically anisotropic film was measured by a spectrometer with an integrating sphere (V7100, manufactured by JASCO Corporation). The MD transmittance and the TD transmittance at a wavelength of 550 nm were determined, and the single transmittance and the degree of polarization were calculated based on the following equation (12) and equation (13). The results are shown in Table 3.

The “MD transmittance” refers to transmittance when the direction of polarization from the Glan-Thompson prism and the transmission axis of the polarizing plate sample with an optically anisotropic film are made parallel, and is described as “MD” in the equation (12) and the equation (13). Also, the “TD transmittance” refers to transmittance when the direction of polarization from the Glan-Thompson prism and the transmission axis of the polarizing plate with an optically anisotropic film cross orthogonally, and is described as “TD” in the equation (12) and the equation (13).

Single transmittance (%)=(MD+TD)/2 Equation (12)

Degree of polarization (%)=√{(MD−TD)/(MD+TD)}×100 Equation (13)

### [Durability Evaluation]

A pressure-sensitive adhesive was bonded onto the surface of the optically anisotropic film, and was put in a heating oven at 80° C. The retardation values R0(549) and R50(549) after 500 hours were measured, and characteristic changes were confirmed. The results are shown in Table 4.

TABLE 3

| | | | Degree of | Single |
|---|---|---|---|---|
| | | | polarization | transmittance |
| | Orientation | Haze (%) | (%) | (%) |
| Example 1 | Vertical | 0.62 | 99.974 | 45.3 |
| | orientation | | | |
| Comparative | Vertical | 1.52 | 99.944 | 44.9 |
| example 1 | orientation | | | |
| Comparative | Vertical | 0.63 | 99.964 | 45.2 |
| example 2 | orientation | | | |

TABLE 4

| | Initial performance | | | After durability test | | |
|---|---|---|---|---|---|---|
| | R0 | R50 | | R0 | R50 | |
| | (549) | (549) | Rth | (549) | (549) | Rth |
| Example 1 | 2.6 | 34.8 | −128 | 2.6 | 35.1 | −129 |
| Comparative | 7.5 | 42.2 | −138 | 4.5 | 38.7 | −136 |
| example 1 | | | | | | |
| Comparative | 2.6 | 34.6 | −127 | 5.5 | 20.1 | −56 |
| example 2 | | | | | | |

It was found out that the optically anisotropic film 1 is excellent in transparency and durability of optical anisotropy.

TABLE 5

| | nx | ny | nz |
|---|---|---|---|
| Example 1 | 1.5722 | 1.5705 | 1.6573 |
| Comparative example 1 | 1.5716 | 1.5666 | 1.6618 |
| Comparative example 2 | 1.5717 | 1.5665 | 1.6619 |

The optically anisotropic film 1 and the comparison optically anisotropic films 1 and 2 were each a positive C plate in which nₓ≈n_{y}<n_{z}.

### Example 2

### Production Example 2 of Optically Anisotropic Film

An optically anisotropic film 2 was produced in the same manner as in Example 1. The film thickness of the optically anisotropic layer was measured using a laser microscope (LEXT3000, manufactured by Olympus Corporation) and found to be 1.0 μm. Optical properties were measured in the same manner as in the optically anisotropic film 1, and the refractive indexes were calculated. The results are shown in Table 6.

### Comparative Example 3

### Production Example 3 of Comparison Optically Anisotropic Film

A comparison optically anisotropic film 3 was yielded in the same conditions as in Comparative Example 1 except that the atmospheric oxygen concentration during photoirradiation was changed to 10000 ppm in Comparative Example 1. The film thickness of the optically anisotropic layer was measured using a laser microscope (LEXT3000, manufactured by Olympus Corporation) and found to be 1.0 μm. Optical properties were measured in the same manner as in the optically anisotropic film 1, and the refractive indexes were calculated. The results are shown in Table 6.

### [Evaluation of Light Leakage]

A cycloolefin polymer film (retardation value R0(549): 110 nm, thickness: 28 μm) was bonded onto the surface on the substrate side of the optically anisotropic film 2, using a pressure-sensitive adhesive. Also, a polarizing plate was laminated on the surface on the optically anisotropic layer side. At this time, the polarizing plate was laminated to make the transmission axis of the polarizing plate substantially orthogonal to the slow axis of the cycloolefin polymer film. The resultant polarizing plate with an optically anisotropic film was bonded onto the viewing side of i-Pad (registered trademark) (manufactured by Apple Inc.) from which the polarizing plate on the viewing side was removed, and light leakage when caused to show black display was visually observed from a direction of an azimuth angle of 45° and an elevation angle of 45° to the panel surface.

The comparison optically anisotropic film 3 was also evaluated in the same manner. The results are shown in Table 6.

TABLE 6

| | R0 | R50 | | | | | Light |
|---|---|---|---|---|---|---|---|
| | (549) | (549) | Rth | nx | ny | nz | leakage |
| Example 2 | 2.6 | 24.5 | −88 | 1.5721 | 1.5695 | 1.6585 | None |
| Comparative | 7.5 | 31.1 | −95 | 1.5723 | 1.5648 | 1.6630 | Leaked |
| example 3 | | | | | | | |

The optically anisotropic film 2 and the comparison optically anisotropic film 3 were a positive C plate in which nₓ≈n_{y}<n_{z}. Also, it was found out that, when the optically anisotropic film 2 was used, no light leakage was found and black was shown in black display, and when the comparison optically anisotropic film 3 was used, light leakage was found and blank was generated in black display.

### INDUSTRIAL APPLICABILITY

According to the present invention, an optically anisotropic film which is excellent in transparency and durability of optical anisotropy can be produced.

### DESCRIPTION OF REFERENCE SIGNS

1, 1′: Retardation film
2, 2′: Polarization film
3, 3′: Adhesive layer
4a, 4b, 4c, 4d, 4e, 4, 4′: Polarizing plate
5, 5′: Adhesion layer
6: Liquid crystal panel
10a, 10b: Liquid crystal display device
11: Film in which composition for forming an optically anisotropic layer is coated onto surface of orientation layer
12: Backup roll
13: Lamp house
14: Lamp
15: Light

1. A method for producing an optically anisotropic film comprising following steps (1) and (2):
(1) a step of coating a composition for forming an optically anisotropic layer containing a polymerizable liquid crystal compound and a photopolymerization initiator onto a surface of an orientation layer, and
(2) a step of irradiating the coated composition for forming an optically anisotropic layer with light in an atmosphere of 0.5% or less of oxygen concentration, while keeping the composition for forming an optically anisotropic layer at a liquid crystal-liquid phase transition temperature of the polymerizable liquid crystal compound or less.

2. The method for producing an optically anisotropic film according to claim 1, wherein, in the step (2), the temperature for keeping the coated composition for forming an optically anisotropic layer is 80° C. or less.

3. The method for producing an optically anisotropic film according to claim 1, wherein, in the step (2), the time for irradiating the coated composition for forming an optically anisotropic layer with light is 5 seconds to 10 minutes.

4. The method for producing an optically anisotropic film according to claim 1, wherein, in the step (2), the oxygen concentration is 0.1% or less.

5. The method for producing an optically anisotropic film according to claim 1, wherein the orientation layer is formed on a substrate surface.

6. The method for producing an optically anisotropic film according to claim 5, comprising bringing a surface on the opposite side of the substrate surface on which the orientation layer is formed into contact with a refrigerant circulation roll, and photoirradiating the substrate surface while keeping the substrate surface at 80° C. or less.

7. The method for producing an optically anisotropic film according to claim 6, wherein the temperature of a refrigerant flowed through the refrigerant circulation roll is 4° C. to 30° C.

8. The method for producing an optically anisotropic film according to claim 6, wherein the time for bringing the surface on the opposite side of the substrate surface on which the orientation layer is formed into contact with a refrigerant circulation roll is 5 seconds to 10 minutes.

9. The method for producing an optically anisotropic film according to claim 5, wherein the substrate is a rolled substrate, and the steps (1) and (2) according to claim 1 are continuously performed.

10. An optically anisotropic film obtained by performing the following steps (1) and (2):
(1) a step of coating a composition for forming an optically anisotropic layer containing a polymerizable liquid crystal compound and a photopolymerization initiator onto the surface of an orientation layer, and
(2) a step of irradiating the coated composition for forming an optically anisotropic layer with light in an atmosphere of 0.5% or less of oxygen concentration, while keeping the composition for forming an optically anisotropic layer at a liquid crystal-liquid phase transition temperature of the polymerizable liquid crystal compound or less.

11. The optically anisotropic film according to claim 10 formed from a vertically oriented polymerizable liquid crystal compound.

12. The optically anisotropic film according to claim 10, wherein the front retardation value Re(549) is 0 nm to 10 nm, and the retardation value Rₜₕ in thickness direction is −10 nm to −300 nm.

13. The optically anisotropic film according to claim 10, which is for an in-plane switching (IPS) liquid crystal display device.

14. A polarizing plate having the optically anisotropic film according to claim 10.

15. The polarizing plate according to claim 14, wherein the degree of polarization is 99.97%.

16. A display device, comprising the optically anisotropic film according to claim 10.
